(19) United States
(12) Patent Application Publication
(10) Pub. No.: US 2005/0204173 A1
(43) Pub. Date: Sep. 15, 2005

(54) Method for automatically filling in user data using fingerprint identification

(75) Inventor: Yen Sheng Chang, Tai Chung Hsien (TW)

Correspondence Address: TROXELL LAW OFFICE PLLC, SUITE 1404, 5205 LEESBURG PIKE, FALLS CHURCH, VA, 22041, US

(73) Assignee: GIGA-BYTE TECHNOLOGY CO., LTD.

(21) Appl. No.: 10/796,130

(22) Filed: Mar. 10, 2004

(51) Int. Cl. H04L 9/00; H04K 1/00; H04L 9/32; G06F 11/30; G06F 12/14

(52) U.S. Cl. 713/202; 713/186

(57) ABSTRACT

The present invention describes a method for automatically filling in user data using fingerprint identification employed in recognizing user's identification. Thus, it creates a web page in first step and then uses the previously saved user's ID, account and password for a database of a specific software application, which is applied to user's ID and password required web page. Meanwhile, user is required to enter the image of user's fingerprint and generate an ID code, and these are checked against the previously saved user's identification information. The user's ID and password according to the corresponding information in the database is retrieved and filled in automatically in that form in the web page if the result of is consistent. The invention can provide a method of identification with security, and also manages user information.

### BACKGROUND OF THE INVENTION

1. Field of the Invention

The present invention relates to a method for automatically filling in user data using fingerprint identification. In particular, the invention is applied to the authentication of automatically filling in user data using and combines a user's fingerprint and a prior method of identification adopted in web page browsing and some software.

2. Description of Related Art

On account of the uniqueness of each person's fingerprint, and because fingers are conveniently inherent to a person's body, personal identification by way of one's own fingerprint is employed in many systems and on many occasions requiring high-security verification. With the advancement of technology, the hardware device for fingerprint input is modularized and also the type of single chip used in numerous IT products and some products for transaction like credit card trade or ATM machines.

At present, the authentication of a user's ID and password is required during sign in for many software applications or web pages. Since the information of user's ID and password is easily forgotten or stolen by hackers, most people are reticent about exchanging personal secret information or conducting other business over the Internet.

With the progression of software technology, currently, an authentication software is developed to allow multiple users with multiple IDs and passwords to access a software application or web pages. This is achieved by combining the user's accounts information and address software application location or correlating a user's accounts and web page addresses. When a user executes an software or signs in on a web page, the user's ID and password are automatically filled in according to the correlation mentioned above.

Even though the prior technology provides a solution to manage easily a user's account, other persons still can obtain information regarding ID and password through specific software and web pages, and an invasion of privacy and secret information is always possible. Consequently, there still remains some unsolved question that how to manage multiple accounts and maintain the secret or privacy at the same time.

Thus, as a result of paying more attention to personal safety and privacy presently and the popularization of technology for fingerprint identification, the present invention provides a method for automatically filling in user data using fingerprint identification combined with management software containing a users' ID and password to solve the above problems.

### SUMMARY OF THE DISCLOSURE

Broadly speaking, the invention relates to a method for automatically filling in user data using fingerprint identification and applies to a process of account management, which is used to verify the identity by inputting a fingerprint. When entering private and secret software or a web page, the invention will fill in the corresponding ID and password automatically, thus providing both security and a more powerful method of managing a user's ID and password.

For achieving the purpose mentioned above, the present invention provides a method for automatically filling in user data using fingerprint identification and comprises the step of creating at least one URL address and a corresponding at least one user's account, ID and password saved in a database. When the user opens an ID and password required URL address, the user is required to input fingerprint image data, and then that image is transferred to an Fingerprint ID code. After that, the current ID code is checked against the previously saved user's identification information; if they are consistent, the corresponding ID and password are retrieved and filled in automatically in that position on that web page.

In a preferred embodiment, the present invention discloses a method for automatically filling in user data using fingerprint identification and comprises steps of creating at least one user's account, ID and password corresponding to an address of a software application. When a user executes that user's ID and password as required by the software application, the user is required to input image data of his own fingerprint, and generate an ID code. After that, this current ID code is checked against the previously saved user's identification information; if they are consistent, the corresponding ID and password are retrieved and filled in automatically on that web page.

Moreover, the present invention discloses a method for automatically filling in user data using fingerprint identification which is used to create the database of a user's ID code for an URL address and a software application and comprise steps of opening the web page or the software application which requires a user's account, ID and password, and filling in that user's ID and password corresponding to an address of the web page or the software application. Furthermore, entering an image of the user's fingerprint is required, and a saved ID code is generated from the image. Database establishment is subsequently finished by retrieving the user's ID and password and saving the corresponding URL address or filename of the software application, the web address and the saved ID code, account and password.

### BRIEF DESCRIPTION OF DRAWINGS

The present invention will be readily understood by the following detailed description in conjunction accompanying drawings, in which:

FIG. 1 is a schematic drawing of framework of the present invention;

FIG. 2 is a schematic drawing of an embodiment of a web page in the present invention;

FIG. 3 is a schematic drawing of an embodiment of software in the present invention;

FIG. 4 is a flow chart of method for creating a Fingerprint ID code in the present invention; and

FIG. 5 is a flow chart of method for automatically signing in according to the present invention.

### DETAILED DESCRIPTION OF THE PREFERRED EMBODIMENTS

To allow the Examiner to understand the technology, means and functions adopted in the present invention further, reference is made to the following detailed description and attached drawings. The Examiner shall readily understand the invention deeply and concretely from the purpose, characteristics and specification of the present invention. Nevertheless, the present invention is not limited to the attached drawings and embodiments in following description.

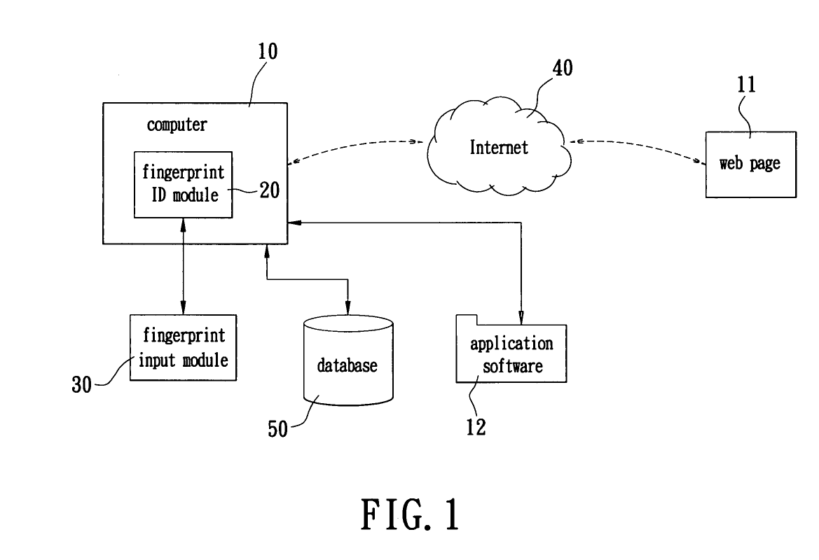

Reference is made to FIG. 1, which is a schematic drawing for demonstrating the present invention. A fingerprint identification module 20 is installed in a computer 10, and electrically connected with a fingerprint input module 30. The computer 10 is connected to the Internet 40 for browsing a plurality of web pages 11 with URL addresses, and a plurality of software 12 can be executed in the computer 10.

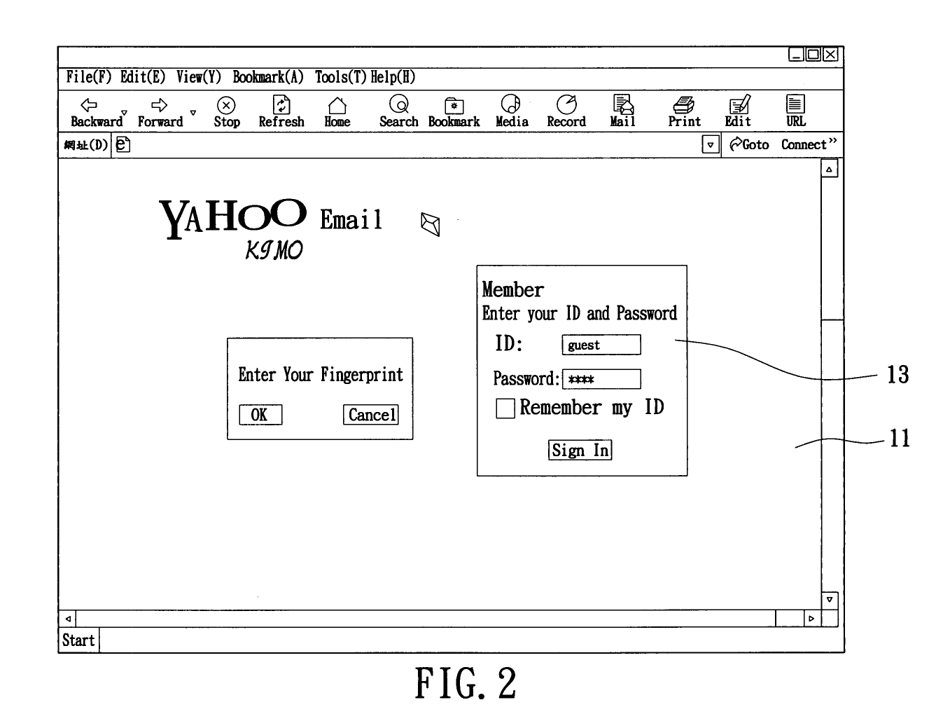

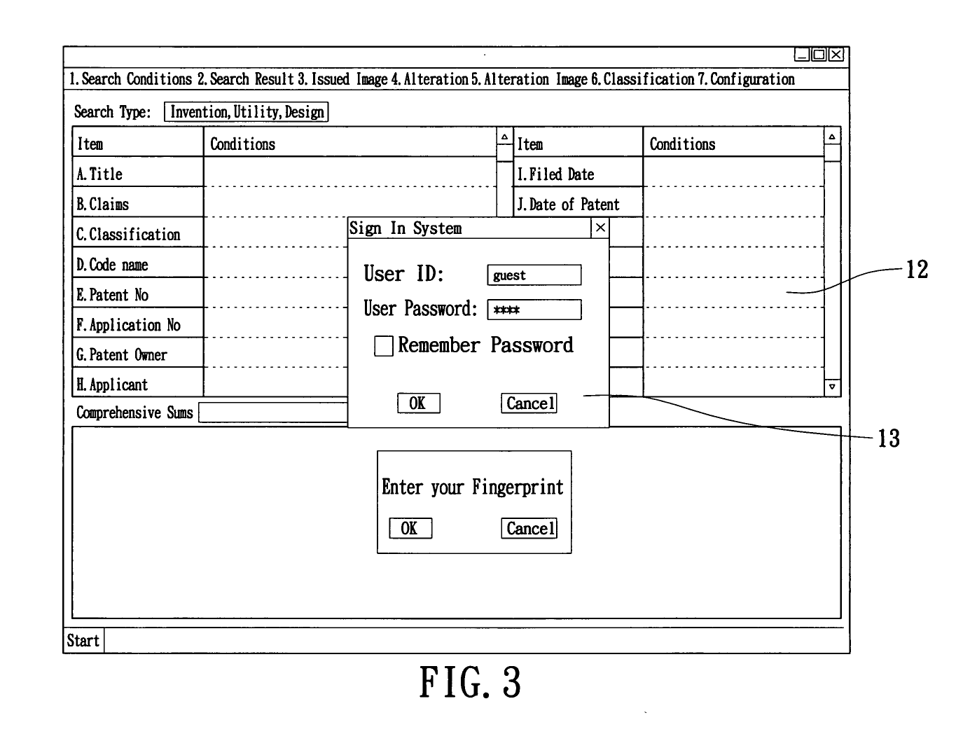

When a user is signing in on web pages 11 or some other software 12, he will see a window 13 requiring that he enter his account and password. FIG. 2 is a schematic drawing showing application of the present invention to a web page, and FIG. 3 is a schematic drawing of an embodiment applying to software. The invention discloses a method for automatically filling in a user's account and password using fingerprint input, and managing multiple user accounts and passwords at the same time. Furthermore, since the fingerprint identification is used, it can achieve best secret protection and security.

As shown in FIG. 1, the finger input module 30 is used for inputting at least one user's fingerprint to produce fingerprint image data, and the fingerprint identification module 20 is used for identifying the characteristics of the fingerprint image data and generating a fingerprint ID code. A database 50 is created to save at least one URL address or the filename, locating address of the software and at least one user's previously saved ID code, account and password. The database 50 can be a non-volatile memory device, like flash memory or a hard disk, the database 50 is electrically connected with the fingerprint identification module 20 and optionally used to store temporarily the fingerprint image data input by the fingerprint input module 30.

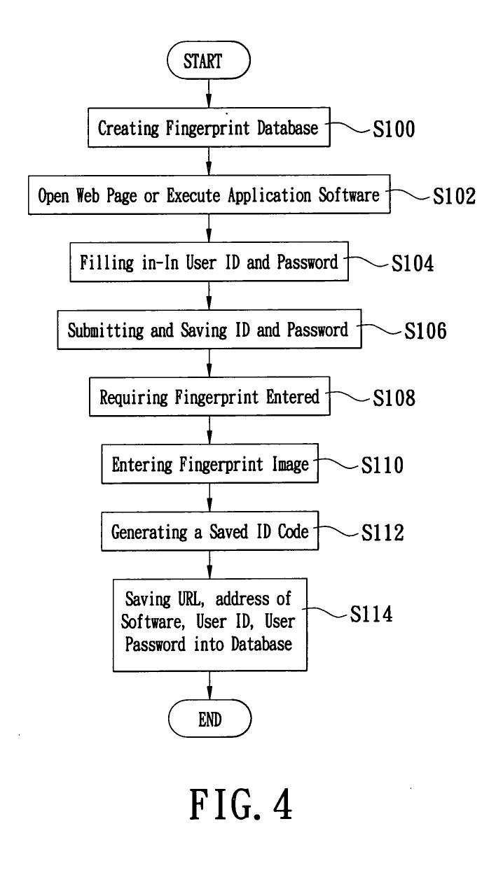

Reference is made to FIG. 4, which is a flow chart of the method for creating a fingerprint ID code in the present invention. The embodiment of this invention relates to a management process of a fingerprint password, by which the database 50 is controlled and managed, and also the automatic sign-in process of a fingerprint password and method can be configured. For the management of the fingerprint database 50, in the first step, the database 50 is created, in which is stored at least one URL address, at least one filename and address of the application software, and at least one user's previously saved ID, account and password corresponding with each URL address and software (step S100).

Associated with the creating process of database 50, in the next step (step S102), a web page requiring the user's account and password is opened, or the software executed requires the user's account and password. Next, the user's account and password are filled into a corresponding position (step S104). When user chooses and clicks on the function of saving the user's account and password (step S106), a pop-up window appears, showing the information and requiring the user to enter a fingerprint, as shown in FIG. 2 and FIG. 3 (step S108). After the user inputs his fingerprint into the fingerprint input module 30, fingerprint image data is produced (S110).

Meanwhile, the fingerprint image data will generate a saved ID code using the fingerprint identification module 20 (step S112), and then the user's account and password are retrieved, the corresponding URL address or the filename and address of the software executed are filled in and stored in the database (step S114).

The process of management in the present invention will detect the URL address and software in which everybody needs to input their own account and password, and further create a user's fingerprint automatically and then produce the saved ID code corresponding with a user's account and password as described above. The method of the present invention can create multiple users in the process of management and identify a plurality of users who use or sign in on the same web page or software using fingerprint identification and corresponding account and password.

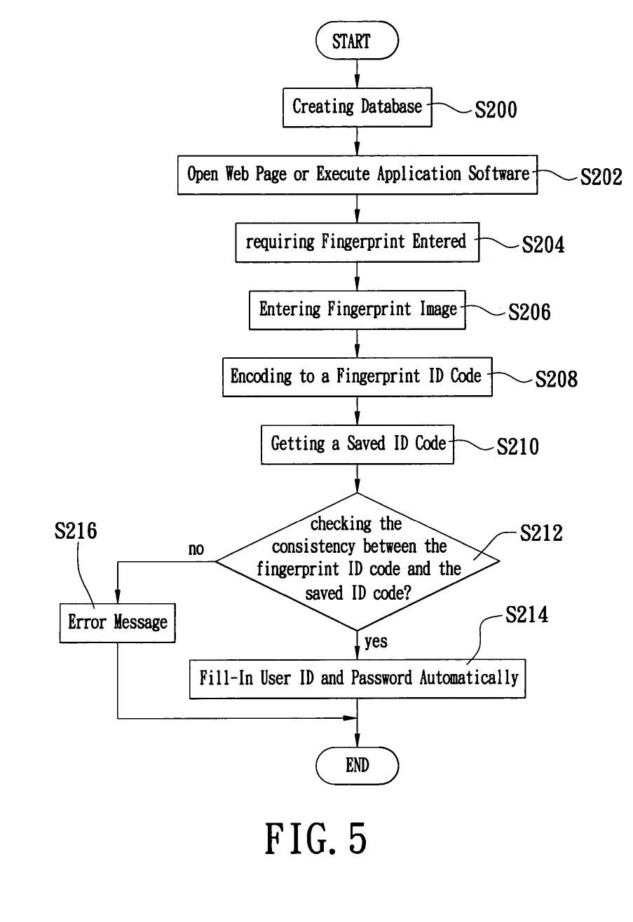

Reference is made to FIG. 5, which is a flow chart of method for automatically signing in according to the present invention. After the user has already created the URL address, the software and the user's saved ID code, account and password in the database 50 (step S200), when opening the same web page, or executing the same software (step S202), there is no need to input the user's account and password again. A window requiring the user to input his own fingerprint pops up automatically in that process (step S204). The user inputs the fingerprint using the fingerprint input module 30 and fingerprint image data is generated (step S206). The fingerprint identification module 20 will retrieve the characteristic value of the fingerprint image data, which is encoded as a fingerprint ID code (step S208).

The ID code saved previously is then retrieved (step S210), and the consistency between the fingerprint ID code and the saved ID code is checked (step S212). If the result is consistent, the user's account is retrieved and the password filled into the position corresponding with a URL address or the software (step S214. An error message window is displayed or pops up if it is not consistent (step S216) and the user is required to input his fingerprint again or informing the user is informed that the fingerprint is not created yet.

If there are many users in the checking process, then consistency is searched and checked one by one between the fingerprint ID code and the saved ID code. If there is any consistency, the saved ID code corresponding with the user's account and password are retrieved from the URL address or the application software, but if there is not any consistency, an error message is displayed.

The other embodiment of the present invention concerns choosing a web page to be opened or software to be executed from the database with a created URL address or software application. The user's account and password are automatically signed in without any remembrance of many accounts and complicated passwords after the fingerprint identification

On the other hand, a management interface exits, beside the display of the created user's information of account in the database, which is editable and erasable, and also can be configured to switch the function of auto-sign in, the history of stored information display and the function of once-fingerprint identification.

In particular, the function of once-fingerprint identification mentioned above is used to verify only one time for only one user, and fingerprint verification is not necessary every time for use. But if there are many users, this function should be switched off to prevent illegal access.

The many features and advantages of the present invention are apparent from written description above and those it is intended by appended claims to cover all. Further, since numerous modifications and changes will readily occur to those skilled in the art, it is not desired to limit the invention to the exact construction and operation as illustrated and described. Hence, all suitable modifications and equivalents may be resorted to as falling within the scope of the invention.

1. A method for automatically filling in user data using fingerprint identification, said method comprising:
creating at least one URL address and at least one user's saved ID code, account and password corresponding to the URL address;
opening a web page designated by said URL address and requiring the user account and password;
inputting fingerprint image data, and generating a fingerprint ID code from entry of said fingerprint image data;
checking for consistency between the fingerprint ID code and the saved ID code; and
retrieving said user's account and password corresponding with said URL address if consistency is established, and filling in the user's account and password in a corresponding position of said web page.

2. The method for automatically filling in user data using fingerprint identification as recited in claim 1, wherein said step of creating said URL address and said user's saved ID code, account and password for includes steps of:
opening at least one web page of said URL address with user's account and password required;
filling in said user's account and password in a corresponding position of said web page;
inputting said user's fingerprint image data;
generating a saved fingerprint ID code from said fingerprint image data;
retrieving said user's account and password; and
saving said URL address and said user's saved ID code, account and password.

3. The method for automatically filling in user data using fingerprint identification as recited in claim 1, wherein said step of creating said URL address creates a database with at least one URL address and at least one said user's saved ID code, account and password saved therein.

4. The method for automatically filling in user data using fingerprint identification as recited in claim 1, wherein said step of inputting said fingerprint image data is performed by a computer system connected with a fingerprint input module for inputting said user's fingerprint and producing said fingerprint image data.

5. The method for automatically filling in user data using fingerprint identification as recited in claim 1, wherein said step of generating said ID code comprises encoding by retrieving a characteristic value of fingerprint from said fingerprint image data by a fingerprint identification module.

6. The method for automatically filling in user data using fingerprint identification as recited in claim 1, wherein before said step of checking for consistency between the fingerprint ID code and the saved ID code further includes:
retrieving said saved ID code corresponding with said URL address.

7. The method for automatically filling in user data using fingerprint identification as recited in claim 1, wherein said step of checking for consistency between the fingerprint ID code and the saved ID code further includes:
searching and checking for consistency between the fingerprint ID code and the saved ID code, one by one;
retrieving said saved ID code corresponding with said user's account and password if there is any consistency; and
displaying a error message if there is no consistency.

8. A method for automatically filling in user data using fingerprint identification, said method comprising:
creating at least one address of software application and at least one user's saved ID code, account and password;
executing said software application with said user's account and password required;
inputting fingerprint image data, and generating a fingerprint ID code;
checking for consistency between the fingerprint ID code and the saved ID code; and
retrieving said user's account and password corresponding with said software application if consistency is established, and filling in said user's account and password in a corresponding position of said software application.

9. The method for automatically filling in user data using fingerprint identification as recited in claim 8, wherein said step of creating said address of said software application and said user's saved ID code, account and password correspondingly further includes steps of:
executing said software application with said user's account and password required;
filling in said user's account and password in a corresponding position of said software application;
inputting said user's fingerprint image data;
generating a saved ID code from said fingerprint image data in a saved fingerprint ID code;
retrieving said user's account and password; and
saving a filename, address of said software application and said user's saved ID code, account and password.

10. The method for automatically filling in user data using fingerprint identification as recited in claim 8, wherein said step of creating said software application is to create a database with at least one filename, address and at least one said user's saved ID code, account and password saved therein.

11. The method for automatically filling in user data using fingerprint identification as recited in claim 8, wherein said step of inputting said fingerprint image data uses a computer system connected with a fingerprint input module for inputting said user's fingerprint and producing said fingerprint image data.

12. The method for automatically filling in user data using fingerprint identification as recited in claim 8, wherein said step of generating said ID code is to encode by retrieving a characteristic value of fingerprint from said fingerprint image data by a fingerprint identification module.

13. The method for automatically filling in user data using fingerprint identification as recited in claim 8, wherein before said step of checking for consistency between the fingerprint ID code and the saved ID code further includes:
retrieving said saved ID code corresponding with said application software application.

14. The method for automatically filling in user data using fingerprint identification as recited in claim 8, wherein said step of checking the consistency between the fingerprint ID code and the saved ID code further includes:
searching and checking for consistency between the fingerprint ID code and the saved ID code, one by one;
retrieving said saved ID code corresponding with said user's account and password if any consistency is established; and
displaying a error message if there is no consistency exists.
